(19) United States
(12) Patent Application Publication
(10) Pub. No.: US 2023/0193975 A1
(43) Pub. Date: Jun. 22, 2023

(54) GAS PRESSURE SPRING AND METHOD FOR PRODUCING THE GAS PRESSURE SPRING

(71) Applicant: STABILUS GmbH, Koblenz (DE)

(72) Inventors: Ulrich Probst, Hillscheid (DE); Alexander Reiser, Münstermaifeld (DE)

(21) Appl. No.: 17/922,404

(22) PCT Filed: May 17, 2021
(86) PCT No.: PCT/EP2021/063018

§ 371 Date: Oct. 31, 2022

(30) Foreign Application Priority Data
May 20, 2020 (DE) 10 2020 113 750.8

(51) Int. Cl. F16F 9/52; F16F 9/02; F16F 9/32; F16F 9/43; E05F 15/616; E05F 3/02

(52) U.S. Cl. CPC F16F 9/526; F16F 9/0218; F16F 9/0236; F16F 9/3271; F16F 9/43; E05F 15/616; E05F 3/02; F16F 2222/126; F16F 2234/02; F16F 2232/08; F16F 2230/42; F16F 2228/066; F16F 2226/04; E05Y 2900/53

(57) ABSTRACT

A gas pressure spring is provided including a working cylinder which, together with a slidably mounted compensating piston, encloses a working chamber filled with a working medium. A slidably mounted working piston is fastened to a working rod. In the event of a temperature increase, a compensating medium in a compensating chamber expands. The compensating piston is acted upon by the pressure of the working medium and the pressure of the compensating medium) such that the volume of the working chamber is increased. The temperature dependency of the gas spring force should be reduced by a design which is as simple as possible. For this purpose, the compensating chamber is at least partially surrounded by the working rod. Thus, the compensating medium can be compactly accommodated, and the assembly of the gas spring is simplified.

### CROSS-REFERENCE TO RELATED APPLICATIONS

This application claims priority to PCT Application No. PCT/EP2021/063018, having a filing date of May 17, 2021, based on German Application No. 10 2020 113 750.8, having a filing date of May 20, 2020, the entire contents both of which are hereby incorporated by reference.

### FIELD OF TECHNOLOGY

The following relates to a gas pressure spring comprising

a) a working cylinder which, together with a compensating piston mounted so that it is slidable relative to the working cylinder, encloses a working chamber filled with a working medium,
b) a working rod protruding into the working chamber through an opening of the working cylinder and mounted so that it is slidable along a stroke axis,
c) a working piston fastened to the working rod and mounted in the working chamber so that it is slidable along the stroke axis,
d) a compensating medium disposed in a compensating chamber and expanding in the event of a temperature increase,
e) wherein the compensating piston is acted upon by the pressure of the working medium and the pressure of the compensating medium such that the volume of the working chamber is increased.
The following further relates to a method for producing such a gas pressure spring.

### BACKGROUND

Gas pressure springs are typically filled with nitrogen so that the resulting spring forces of the gas pressure springs are subject to temperature fluctuations, i.e., the contained gas expands when the temperature T rises and contracts when the temperature T drops, or the gas pressure p increases or decreases at a constant volume V (for an ideal gas, the following applies: p*V=n*R*T). In some applications, this causes problems so that it would be advantageous to completely or partly compensate this physical effect.

For example, when used in a tailgate of a vehicle, the temperature dependency of the spring force results in that the gas pressure spring has to be designed so that it is stronger than required at most temperatures to provide for a sufficient spring force even at low temperatures (e.g., at −30 to 0 C° (e.g., to reliably keep the tailgate open). However, this, on average, increases the wear of the gas pressure spring since it is usually operated at medium temperatures (e.g., from 0° bis 25° C.). At the same time, when operated manually, the ease of operation decreases at higher temperatures (e.g., more than 25° C.) since a relatively large force is required to recompress the gas pressure spring (e.g., when closing the tailgate). In case of an automatic drive (e.g., of a self-opening tailgate), also a higher driving force is required to overcome the spring force at high temperatures.

EP 1 795 777 B1 describes a gas pressure spring comprising a working cylinder which, together with a compensating piston arrangement, encloses a working chamber filled with a working medium. A working rod slidably protrudes into the working chamber through an opening of the working cylinder, the compensating piston arrangement being acted upon by the pressure of the working medium and the pressure of a compensating medium provided in a compensating chamber and expanding in the event of a temperature increase such that the volume of the working chamber is increased. A compensating cylinder surrounding the working cylinder at a distance extends beyond the working cylinder at its end removed from the working rod exit end of the gas pressure spring and is closed on this end. The compensating chamber is substantially formed by a ring-shaped chamber between the working cylinder and the compensating cylinder. The compensating medium thus reduces the temperature dependency of the gas pressure spring force to a certain extent by adapting the volume available to the working medium depending on the temperature.

Presently, a plurality of non-optimal solutions is offered for solving the problem of conventional art:

1. Temperature compensation by activating additional volume at low temperatures, for example through a temperature-dependent valve,
2. the use of suspension struts, i.e., particularly of a combination of a gas pressure spring and a mechanical spring, as well as
3. the use of a compensating medium for reducing the temperature dependency described in EP1795777B1.

The first option has a limited degree of temperature compensation, and the overall length of the devices increases extremely.

The second option is disadvantageous in that sufficiently dimensioned suspension struts are, in the relation, very expensive to produce and have an unfavourable spring characteristic. Apart from that, the temperature dependency cannot be fully eliminated.

The third option is, in the known variants, extremely complicated and cannot be implemented in a cost-effective manner, particularly with regard to assembly. At present, this implementation can only be produced in manual assembly lines (i.e., mainly manually), a production in semi- or fully automatic machines seems impossible.

### SUMMARY

An aspect relates to a gas pressure spring of the type mentioned in the introduction which has a temperature dependency of the spring force, which is as low as possible and, at the same time, a design which is as simple as possible.

The at least partial arrangement of the compensating chamber in the working rod is advantageous in that the design of a gas pressure spring including a compensating medium for temperature compensation requires significantly less installation space. To obtain space for the compensating medium, for example, the radius of the working rod can be slightly increased to provide a cavity at unchanged stability. On principle, the compensating medium may thus be accommodated without or with only a slight increase in the overall length. This is important since, in numerous applications, there are limitations to the possible overall length of the gas pressure spring (e.g., in tailgates in the automotive sector).

At the same time, the compensating medium can be installed together with the working rod and therefore facilitates assembly. In contrast, e.g., the design became significantly more complicated due to the ring-shaped arrangement of the expansion material described in EP1795777B1.

In an embodiment, the compensating chamber is at least partially surrounded by the working rod so that it is tight with respect to the compensating medium.

In an embodiment, the compensating chamber is at least partially surrounded by the working rod so that it is pressure-stable with respect to the compensating medium. In this way, the working rod can withstand the variable pressures of the compensating medium and the working medium.

As compared to the use of a suspension strut (option 2), the production costs can also be reduced since no expensive mechanical spring is required. At the same time, the weight is also generally lower than when suspension struts are used.

The solution according to embodiments of the invention also has a better functionality than a temperature-dependent valve (option 1) i.e., a higher degree of compensation of the temperature dependency.

The assembly of the gas pressure spring is facilitated as compared to known models including a compensating medium, and even an automatic assembly is possible. A detrimental influence on the service life is not to be expected, a better temperature compensation tendentially enabling a more well dimensioned spring force so that also wear can, on average, be reduced.

In an embodiment, the gas pressure spring comprises a compensating container having an inner chamber, fastened to the working piston and in the working cylinder, and mounted so that it is slidable along the stroke axis, the compensating piston dividing the inner chamber into an inner working chamber conductively connected to the working chamber for the working medium, and a return chamber sealed with respect to the working chamber. This embodiment enables a simple assembly since the compensating container can be preinstalled on the working piston and then mounted in the working cylinder together with the working piston in one step. The other mounting steps may substantially remain the same as compared to gas pressure springs without a compensating mechanism.

In one embodiment, the working rod comprises a tappet which can be driven out of the working rod by the pressure of the compensating medium, and the tappet applies the pressure of the compensating medium to the compensating piston such that the volume of the inner working chamber is increased. The use of the tappet allows for a more compact accommodation of the compensating medium since also a relatively slight increase in the volume of the compensating medium renders a relatively large axial stroke of the tappet possible. In this way, the change of the volume of the working chamber does not have to be achieved by the change of the volume of the compensating medium itself, but it can be achieved by the relative movement of the tappet and of the working chamber.

In an embodiment, the compensating medium is an expanding material, an expanding wax, an oil, or a two-phase medium, wherein the compensating medium may particularly be configured as described in EP 1 795 777 B1, wherefrom the advantages mentioned there will unfold.

In one embodiment, the gas pressure spring comprises a return medium accommodated in the return chamber, the compensating piston being acted upon by the return medium such that the volume of the working chamber, for example of the inner working chamber, is reduced. In this way, it can be ensured, in the simplest possible manner, that, in case of a contraction of the compensating medium at lowering temperatures, the compensating piston will also return to the initial position, i.e., a reversible operation is ensured. With the reduction of the volume of the compensating medium, then, a corresponding reduction of the volume of the compensating chamber will be induced by the return medium.

In an embodiment, the return medium is a gas, particularly the working medium. This facilitates the production of the gas pressure spring since only one medium or gas is used. In addition, or as an alternative to a gaseous return medium, the return medium may comprise a mechanical return spring in the return chamber.

The aspect according to embodiments of the invention is also solved by a method for producing a gas pressure spring according to one of the above embodiments, the method being characterised by the following steps:

a) providing the working cylinder for the gas pressure spring,
b) providing the working rod including a compensating chamber for the gas pressure spring,
c) filling the compensating medium into compensating chamber,
d) mounting the working rod in the working cylinder. Thus, in contrast to conventional art, the compensating medium is installed together with the “main components” of the gas pressure spring also provided for in conventional art. In this method, as compared to known gas pressure springs, the installation of the gas pressure spring including the compensating medium is therefore significantly facilitated, and even an automatic assembly becomes possible.

In one embodiment, the method comprises the following steps:

fastening the tappet and/or the compensating container to the working rod prior to mounting. The tappet and/or the compensating container as well as the working rod may then be inserted into the working cylinder together which simplifies the design.

In an embodiment, the method comprises the steps:

a) Simultaneously filling the working chamber and the return chamber with the working medium, such as through a check valve between the working chamber and the return chamber, and
b) discharging part of the working medium from the working chamber after filling. In this way, the assembly of the gas pressure spring can be accelerated and facilitated. Discharging part of the working medium facilitates the exact adjustment of the gas pressure spring force.

The aspect according to embodiments of the invention is also solved by a drive system for a flap including

a) a gas pressure spring according to one of the above embodiments for supporting the flap and
b) an electromechanical drive, for example a linear drive, particularly a spindle drive, for driving the flap.
For example, the flap may be a flap of a vehicle, particularly a bonnet, a tailgate, a boot lid, or a swing door.

Drive systems for a flap including a gas pressure spring for supporting the flap and an electromechanical drive for driving the flap are known in conventional art. Except for the use of a gas pressure spring according to embodiments of the invention instead of a generic one, the drive system according to embodiments of the invention may be designed like a corresponding drive system according to conventional art, for example, according to DE 103 13 440 A1 or DE 10 2008 045 903 A1.

The gas pressure spring of the drive system serves to retain the flap in any position against gravity while the electromechanical drive serves to open and close the flap. Moreover, a manual operation of the flap may be contemplated like in DE 103 13 440 A1 and DE 10 2008 045 903 A1.

The gas pressure spring has to have a spring force which is so high that it can support the flap even at low ambient temperatures. Since the spring force of common gas pressure springs increases at rising temperatures this will result in that, at high temperatures, an extremely strong force has to be applied by the electromechanical drive or an operator to close the flap. Therefore, the drive system has to comprise an extremely powerful electromechanical drive which is expensive, requires a large installation space and consumes a lot of energy in operation. Apart from that, there will be excessive wear of the electromechanical drive and of other parts mechanically connected to the flap, for example hinges.

In conventional art, these problems are evaded by the use of a suspension strut instead of the gas pressure spring (e.g., DE 10 2008 045 903 A1, para. [0021]). A suspension strut may have an almost temperature-independent spring force, but it is larger, heavier, and more expensive than a gas pressure spring having a comparable spring force.

With the use of a temperature-compensated gas pressure spring according to embodiments of the invention instead of a standard gas pressure spring, therefore, a drive system for a flap is provided which is particularly cost-effective, easy to produce, enduring, compact, energy-saving and easy to operate.

### BRIEF DESCRIPTION

Some of the embodiments will be described in detail, with references to the following Figures, wherein like designations denote like members, wherein:

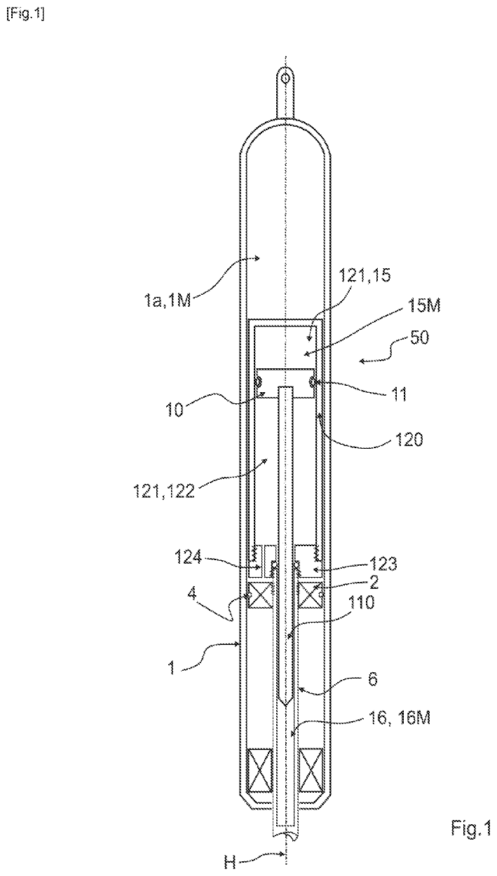

FIG. 1 shows an embodiment of a gas pressure spring according to embodiments of the invention in a first position of the compensating piston; and

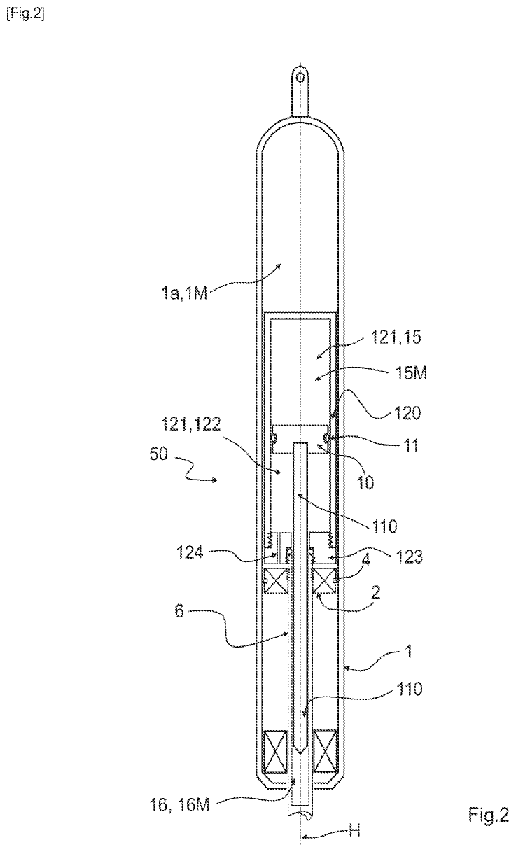

FIG. 2 shows the embodiment of FIG. 1 in a second position of the compensating piston.

### DETAILED DESCRIPTION

In FIGS. 1 and 2, a first embodiment of a gas pressure spring 50 according to embodiments of the invention is illustrated which comprises a working cylinder 1 which, together with a compensating piston 10 mounted so that it is slidable relative to the working cylinder 1, encloses a working chamber 1a filled with a working medium 1M. Here, a working rod 6 mounted so that it is slidable along a stroke axis H protrudes into the working chamber 1a through an opening of the working cylinder 1.

On the working rod 6, a working piston 2 mounted in the working chamber 1a so that it is slidable along the stroke axis H is fastened. The working piston 2 comprises a ring-shaped seal 4 (e.g., an O ring) towards the radially inner wall of the working cylinder 1 so that, when the working piston 2 is shifted, the working medium 1M cannot flow around the working piston 2. A shift of the working piston 2 will therefore first result in a change in the pressure in the working chamber 1a. However, the working piston 2 may comprise a throttle bore (not illustrated), and/or the radially inner wall of the working cylinder 1 may have a longitudinal groove along the stroke axis H of the working piston 2 for pressure compensation.

A compensating medium 16M is disposed in a compensating chamber 16 and expands in the event of a temperature increase. The compensating piston 10 is acted upon by the pressure of the working medium 1M and the pressure of the compensating medium 16M such that the volume of the working chamber 1a is increased.

Here, FIG. 1 shows a high temperature situation while FIG. 2 shows a low temperature situation.

The compensating chamber 16 is partially surrounded by the working rod 6 here. In particular, the compensating chamber 16 is surrounded by the working rod 6 and a tappet 110.

[1] The gas pressure spring 50 comprises a compensating container 120 which has an inner chamber 121, is fastened to the working piston 2, and mounted in the working cylinder 1 so that it is slidable along the stroke axis H. The compensating piston 10 divides the inner chamber 121 into an inner working chamber 122 conductively connected to the working chamber 1a for the working medium 1M, and a return chamber 15 sealed with respect to the working chamber 1a. For this purpose, the compensating piston comprises a circumferential seal 11, e.g., an O ring.

For connecting the working chamber 1a to the inner working chamber 122, e.g., a hole 124 is provided in a connecting member 123 connecting the compensating container 120 to the working rod 6. The working medium 1M may flow through between the compensating container 120 and the working cylinder 1 (e.g., through a space between compensating container 120 and working cylinder 1 radial to the stroke axis H or through at least one longitudinal groove along the stroke axis H in an inner wall of the working cylinder 1 or an outer wall of the compensating container 120).

The working rod 6 comprises the tappet 110 which can be driven out of the working rod 6 by the pressure of the compensating medium 16M. The tappet 110 applies the pressure of the compensating medium 16M to the compensating piston 10 such that the volume of the inner working chamber 122 is increased.

Driving the tappet 110 out of the working rod 6 in the event of a temperature increase will then lead to a shift of the compensating piston 10 relative to the compensating container 120 along the stroke axis H (upwards in the drawing). In this way, the inner working chamber 122 and therefore the entire working chamber 1a available to the working chamber 1M is enlarged. As compared to FIG. 1, FIG. 2 shows a state at a low temperature and with the tappet 110 contracted further into the working rod 6.

The compensating medium 16M is, for example, an expanding material, such as an expanding wax which particularly comprises at least a liquid phase and at least a solid phase in an entire operating temperature range of the gas pressure spring 50.

The gas pressure spring 50 comprises a return medium 15M disposed in the return chamber 15, the compensating piston 10 being acted upon by the return medium 15M such that the volume of the working chamber 1a such as the inner working chamber 122, is reduced. In this way, it can be ensured in the simplest possible manner that, in the event of a contraction of the compensating medium 16M at dropping temperatures (FIG. 1->FIG. 2), the compensating piston 10 is also returned to the initial position, i.e., that a reversible operation is ensured. With the reduction of the volume of the compensating medium 16M, the return medium 15M will then provide for a corresponding reduction of the volume of the compensating chamber 16. For supporting the return medium 15M, the gas pressure spring 50 may additionally also comprise a return spring in the return chamber 15 (not shown in the illustrated embodiment).

In an embodiment, the return medium 16M is a gas, particularly the working medium 1M. This facilitates the production of the gas pressure spring 50 since only one medium or gas is used.

In FIG. 1, as compared to the situation in FIG. 2, the working medium 1M is thus disposed in a larger working chamber 1a (particularly a larger inner working chamber 122) in the same position of the working piston 2. Therefore, the temperature-related increase in the pressure of the working medium 1M can be partly or even fully compensated by the increase in the volume of the inner working chamber 122. Thus, the gas pressure spring 50 provides for a significantly less temperature-dependent spring force than conventional art.

Although the invention has been illustrated and described in greater detail with reference to the preferred exemplary embodiments, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

### LIST OF NUMERALS

1 Working cylinder
1a Working chamber
1M Working medium
2 Working piston
4 Seal
10 Compensating piston
11 Seal
15 Return chamber
15M Return medium
16 Compensating chamber
16M Compensating medium
50 Gas pressure spring
110 Tappet
120 Compensating container
121 Inner chamber
122 Inner working chamber
123 Connecting member
124 Hole
H Stroke axis

1. A gas pressure spring comprising:
a) a working cylinder which, together with a compensating piston mounted so that it is slidable relative to the working cylinder, encloses a working chamber filled with a gaseous working medium;
b) a working rod protruding into the working chamber through an opening of the working cylinder and mounted so that it is slidable along a stroke axis;
c) a working piston fastened to the working rod and mounted in the working chamber so that it is slidable along the stroke axis;
d) a compensating medium disposed in a compensating chamber and expanding in the event of a temperature increase;
e) wherein the compensating piston is acted upon by the pressure of the working medium and the pressure of the compensating medium such that the volume of the working chamber increased;
wherein
f) the compensating chamber is at least partially surrounded by the working rod;
g) wherein the gas pressure spring comprises a compensating container having an inner chamber, fastened to the working piston, and mounted in the working cylinder so that it is slidable along the stroke axis;
h) wherein the compensating piston divides the inner chamber into an inner working chamber conductively connected to the working chamber for the working medium and a return chamber sealed with regard to the working chamber;
i) wherein the gas pressure spring comprises a return medium disposed in the return chamber;
j) wherein the compensating piston is acted upon by the return medium such that the volume of the inner working chamber is reduced;
k) wherein the return medium the gaseous working medium; and
l) wherein the gas pressure spring comprises a check valve between the working chamber and the return chamber for simultaneously filling the working chamber and the return chamber with the working medium.

2. The gas pressure spring according to claim 1,
wherein
a) the working rod comprises a tappet which can be driven out of the working rod by the pressure of the compensating medium; and
b) the tappet applies the pressure of the compensating medium to the compensating piston such that the volume of the inner working chamber is increased.

3. A method for producing a gas pressure spring according to claim 1,
wherein
a) providing the working cylinder for the gas pressure spring;
b) providing the working rod having a compensating chamber the gas pressure spring;
c) filling the compensating medium into the compensating chamber;
d) mounting the working rod in the working cylinder;
e) simultaneously filling the working chamber the return chamber of the gas pressure spring through the check valve of the gas pressure spring between the working chamber the return chamber with the gaseous working medium, and
f) discharging part of the working medium from the working chamber after filling.

4. The method according to claim 3,
wherein
fastening the tappet and/or the compensating container to the working rod prior to mounting.

5. A drive system for a flap including:
a) a gas pressure spring according to claim 1 for supporting the flap, and
b) an electromechanical drive for driving the flap.
